(19) United States
(12) Patent Application Publication
(10) Pub. No.: US 2011/0252893 A1
(43) Pub. Date: Oct. 20, 2011

(54) DEVICE FOR MEASURING RATES IN INDIVIDUAL PHASES OF A MULTIPHASE FLOW

(75) Inventors: Kjetil Fjalestad, Skien (NO); Torbjørn Fiveland, Skien (NO); Robert Aasheim, Porsgrunn (NO); Are Mjaavatten, Porsgrunn (NO)

(73) Assignee: STATOIL PETROLEUM AS, Stavanger (NO)

(21) Appl. No.: 13/119,455

(22) PCT Filed: Sep. 18, 2009
(86) PCT No.: PCT/NO09/00327

§ 371 Date: Apr. 28, 2011

(30) Foreign Application Priority Data
Sep. 18, 2008 (NO) 20083981

(51) Int. Cl. G01F 1/74

(52) U.S. Cl. 73/861.04

(57) ABSTRACT

A device for measuring rates in individual phases of a multiphase flow, such as in flow of hydrocarbon fluid through a pipe line, comprising a venturi having, seen in the flow direction thereof, a first inlet portion with deceasing cross-section, a second intermediate portion with mainly uniform cross-section, and a third outlet portion with increasing cross-section, and being situated within the pipe line. According to the present invention, the venturi is provided with a number of sensors, and the sensors are arranged in mutual distance at different cross-section areas along at least the first of the three portion of the venturi as thereby being able to determine a pressure profile along the venturi as a base for estimating rates for actual rates of the flow.

The present invention is primarily relating to multiphase measurement of fluids flowing in operational facilities, e.g. a transport pipe for hydrocarbons from a producing wellbore in processing facilities, either onshore or offshore under or over the surface.

Due to problems arising from multiphase meters in operational facilities, in particular problems of the dynamic type originating from slug formation, it is desirably to provide better meters for rates in pipe flows having more phases. With a good model for flow through a venturi or orifice meter, it is possible to determine rates for gas and liquid through the constriction.

A simple model for a choke valve providing that the phases flow independently, consequently without any transmission of mass or energy transmission between the phases, is having good presupposed properties on tests already been executed in the multiphase rig on Herøoya. The model is given by (1).

$$w = {k}_{C} \frac{{Y}_{Gas} \sqrt{{ρ}_{Gas} ( {p}_{1} - {p}_{2} )}}{1 + {x}_{Liq} ( {Y}_{Gas} \sqrt{\frac{{ρ}_{Gas}}{{ρ}_{Liq}}} - 1 )} \qquad ( 1 )$$

Where w is mass flow, k_{C} is a constant, p₁ and p₂ are pressure at inlet and outlet, ρ_{Gas} and ρ_{Liq} are the density of the phases, and Y is the expansion factor of the gas. In addition is:

$$\begin{matrix}{x}_{P} = \frac{{p}_{1} - {p}_{2}}{{p}_{1}} & ( 2 ) \\ Y = 1 - \frac{{x}_{P}}{3 {F}_{k} {x}_{TP}} & ( 3 ) \\ {F}_{k} = \frac{γ}{1.4} = \frac{{C}_{P}}{1.4 {C}_{V}} & ( 4 )\end{matrix}$$

Where γ is the adiabatic exponent of the gas. Further, the constant can be determined by the area, A, of the opening into the choke valve:

$${k}_{C} = A \sqrt{2} \sqrt{{10}^{5}} = 447 A \\ ( {C}_{V} = \frac{A}{{N}_{1}} \sqrt{\frac{{2.10}^{5}}{{ρ}_{Water}}} 3600 = 58860 A ) \qquad ( 5 )$$

The presupposed properties of the model having a choke valve from more than 500 tests are further shown in FIG. 1.

A corresponding model can be made for flow through a venturi being the base for the present invention.

$$\begin{matrix}{w}_{L} = {A}_{L , i} \sqrt{\frac{2 {ρ}_{L , 1}}{1 - {m}_{L , i}^{2}} ( {p}_{1} - {p}_{i} )} , \\ {m}_{L , i} = \frac{{A}_{L , i}}{{A}_{L , 1}} & ( 6 ) \\ {w}_{G} = {{A}_{G , i} ( \frac{{p}_{i}}{{p}_{1}} )}^{\frac{1}{γ}} \sqrt{{ρ}_{G , 1} {p}_{1} \frac{2 γ}{γ - 1} \frac{1 - {( \frac{{p}_{i}}{{p}_{1}} )}^{1 - \frac{1}{γ}}}{1 - {{m}_{G , i}^{2} ( \frac{{p}_{i}}{{p}_{1}} )}^{\frac{2}{γ}}}} , \\ {m}_{G , i} = \frac{{A}_{G , i}}{{A}_{G , 1}} = \frac{{A}_{i} - {A}_{L , i}}{{A}_{1} - {A}_{G , 1}} & ( 7 ) \\ {A}_{L , i} = \frac{{w}_{L}}{\sqrt{2 {ρ}_{L} ( {p}_{1} - {p}_{i} ) + {ρ}_{L}^{2} {u}_{1}^{2}}} & ( 8 )\end{matrix}$$

In the equation set (6) to (8), there are the three unknown variables, namely the mass flow of liquid, w_{L}, the mass flow of gas, w_{G}, and the inflow velocity of liquid, uₗ. By measuring the pressures in more than three points having different areas, A, the equation set gives a redundant system, whereby the rates can be determined.

With reference to the equations, it is referred to the nomenclature being listed after the detailed description of the invention and as an additional explanation thereof.

Friction between phases and also between phases and wall is possibly having greater importance within a venturi than in a choke valve. If that is the case, the model must handle this fact, then by adequate corrections of the equations (6) to (8), possibly based on more tests to achieve better results.

As further deepening of the model with a venturi, the following is to be noted. In a pipe flow having a phase, equation (6) and equation (7) are used for liquids and gas, respectively. By means of two positions with different and known areas, A, and measured pressure, p, and also known properties for the phase to be measured i.e. density at the inlet, ρ, and as well for gases the adiabatic factor, γ, the mass flow, w, can be estimated. If there are two, or in so far as more phases at the same time, more measurements and known data are needed to be able of solving the equations. For given gases and liquids, the properties being needed in the equations (6) to (8) are known. For given venturies are the area, A, known at the positions where the pressure is measured. This is involving that the pressure has to be measured in at least three positions having different area to be able of determining the flow rates of liquid, w_{L}, and gas, w_{G}.

To determine rates of different phases within a pipe flow, it is possible to utilize the model above. Other models describing the connection between pressure drop and properties such as density, compressibility, or the like of each phase as such can also be utilized. To determine the rate of different phases, at first gas and liquid, it is then possible to utilize more conventional instruments in series, e.g. two venturies after one another, an orifice meter, and a valve in series, or the like.

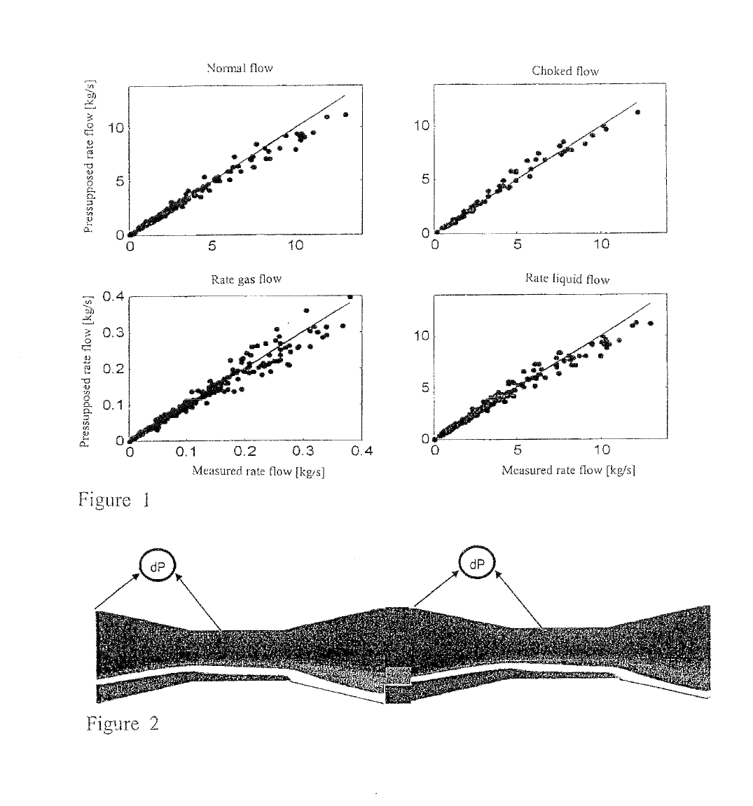

It is also possible to make an instrument for measuring two rates by having two venturi nozzles situated after one another as shown in FIG. 2. The venturi nozzles must have different configuration whereby they provide for different pressure drop and thereby sufficient information to solve the equations above.

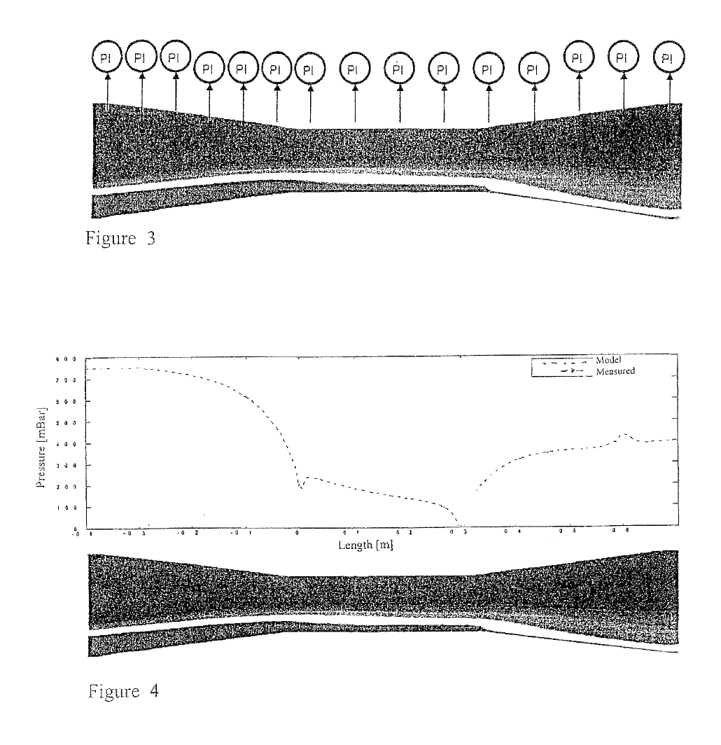

In stead of using more venturies in series, it is simpler and better utilizing only one venturi in which it is executed more pressure measurements as shown in FIG. 3. Then, the differential pressure between each of the sensors is determined. The respective sensor is situated at different opening areas within the constriction area of the venturi. The rate can consequently be measured in the form of a pressure profile through the constricted portion of the venturi. However, it is also possible to use pressure measurements through the narrowest area and also the increasing area of the venturi.

Arbitrary pressure sensors to measure the profile can be used but for most applications micro-sensors arc well suited. By distributing the sensors along the flow direction in the venturi, a pressure profile can be determined as shown in FIG. 4.

To have more accurate pressure measurements, measuring differential pressure between each position to determine the pressure drop between each sensor can be considered as a favourable alternative. The effect of inaccuracy in each could be reduced by using more sensors than required to determine the rates i.e. the system should involve redundancy. This is also improving the durability. Problems with one or some of sensors are then eliminated by not using this or the actual ones to estimate the rates.

FIG. 4 shows a venturi measuring differential pressure between outflow, possibly against inflow, and each point along the venturi. The accuracy becomes much better than having the measurement of a pressure profile as outlined in FIG. 3. In addition to the differential pressure sensors being specified above, the absolute pressure should be measured. If more measurements than needed are used, the system is redundant in a manner that the solution according to the model using an estimate from the equations (6) to (8) provides for more accurate rates

In view of the description above, it is according to the present invention therefore provided a device for measuring rates in individual phases of a multiphase flow such as in flow of hydrocarbon fluid through a pipe line comprising a venture having, seen in the flow direction thereof, a first inlet portion with deceasing cross-section, a second intermediate portion with mainly uniform cross-section, and a third outlet portion with increasing cross-section, and being situated within the pipe line, wherein the venturi is provided with a number of sensors, and the sensors are arranged in mutual distance at different cross-section areas along at least the first of the three portion of the venturi as thereby being able to determine a pressure profile along the venturi as a base for estimating rates for actual rates of the flow.

Favourable embodiments are understood from the dependent patent claims and the additional description below.

The main elements of the present device can without being understood to involve any restriction briefly summarized as:

a venturi having pressure sensors situated at more different flow areas,
using differential pressure sensors versus a known common pressure as to achieve improved measure accuracy, and
using a flow model to determine flow volumes based on measured pressure and properties of the fluids i.e. the phases and also configuration of the venture as such

Thereby, the device could be used in connection with most oil wells and, thus, contribute to determination of the rate for both gas and liquid such as oil and water from each respective well which is very useful for better operation thereof.

The present invention is now to be explained in more detail with reference to the accompanying drawings, in which:

FIG. 1 shows presupposed properties for model having a choke valve;

FIG. 2 illustrates venturies in series for determining more phases;

FIG. 3 depicts a venturi having pressure measurements for a pressure profile through three portions of the venturi;

FIG. 4 shows the resulting pressure profile according to measurements from FIG. 3, partly as model estimates and measured values; and

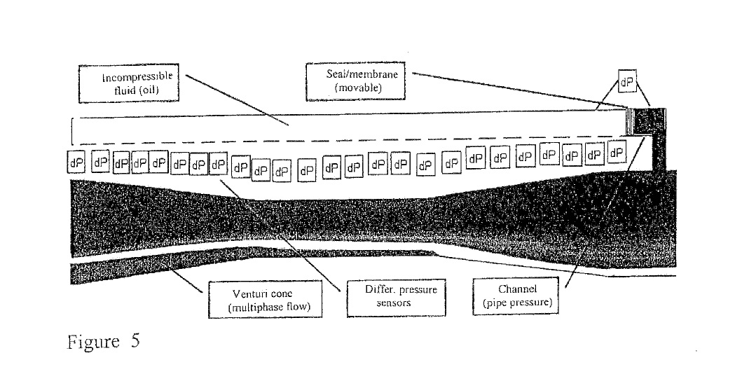

FIG. 5 illustrates a venturi having differential pressure sensors for measuring the pressure profile.

As many of the important circumstances according to the present invention already have introductorily been discussed, it is no reason to repeat these here in the following. It should be noted that the measuring results from the different sensors being arranged at the respective portion of the venturi, and being decisive for the determination of rates for the phases in the flow of hydrocarbon produced from a subsea well, for instance, of course have to be communicated to an accessible location or equipment for additional processing by means of the estimating model mentioned above. However, such a communication is not the essential factor in connection with the invention, and can of course be executed in many appropriate manners not considered necessary to discuss in detail. The actual control of the hydrocarbon flow based on the determination of the respective phases is neither necessary to comment further in this description of the invention.

The present device for measuring rates in individual phases of a multiphase flow has two main components, more exact a venturi and a number of sensors situated therealong. The venturi is mounted in any convenient manner, not shown, sealingly engaged at an inner surface within the actual pipe line as to form a constriction. As shown in FIG. 3, for instance, the venturi has in the flow direction thereof a first inlet portion narrowing cross-section, a second intermediate portion having mainly uniform cross-section, and a third outlet portion with increasing cross-section. It is clearly understood that more venturies can be utilized, e.g. two and, then, mounted closely to one another as shown in FIG. 2 or, if appropriate, distant from one another. The dimensions of the different portions within the venturi can be adapted to the actual need, for instance, by changing the lengths and variations in cross-section reduction or increase thereof, and possibly being similar or different from one another.

To be able of executing the measurements which are the base for estimating phase rates with the model according to the equations (6) to (8) mentioned above, the venturi is equipped with a number of sensors mutually spaced along the venturi. It is believed most practical to locate sensors along all of the three portions within the venturi as this is allowing for a greater number of measurements of pressure values and, thus, a significant redundancy when determining the rates for the different phases of the flow. In its most simple version, it is as such sufficiently having a measurement at the inlet and conical constriction within the first position of the venturi, whereby sensors is only needed within the portion of the venturi. However, it is no reason to disregard that measurements at the conical enlargement within the third portion and outlet, or in so far as also within the intermediate portion can contribute to more reliable results for the estimated rates and, thereby, is considered favourably.

A larger number of sensors along the respective portions within the venturi are also allowing a variation in measurements at different positions along the venturi. In the simplest version only three sensors are needed at the respective portion of the venturi. The minimal number to be able of achieving the redundancy needed when determining the phase rates is four sensors.

It can be utilized many different sensor types in connection with the present invention. One possibility is microsensors as indicated in FIG. 3 due to size and measuring accuracy. Differential pressure sensors are also well suited, if it is favourably with measuring pressure drop over the venturi as depicted in FIG. 5.

Nomenclature

| Symbol | Denotation | Value / Formula | Unit |
|---|---|---|---|
| A | Area, therefore ion | | [m²] |
| γ | Adiabatic exponent (γ = 1.4 for air) | $γ = \frac{{C}_{P}}{{C}_{V}}$ | |
| p | Pressure | | [Bar] |
| q | Rate volume flow | | [m³/s] |
| ρ | Density | | [kg/m³] |
| u | Fluid velocity | | [m/s] |
| V | Volume | | [m³] |
| w | Rate mass flow | | [kg/s] |
| X_{Liq} | Liquid mass fraction | ${X}_{Liq} = \frac{{m}_{Liq}}{m} = \frac{{m}_{Liq}}{{m}_{Gas} + {m}_{Liq}}$ | |
| X_{P} | Pressure drop ratio | ${X}_{p} = \frac{{p}_{1} - {p}_{2}}{{p}_{1}}$ | |
| X_{TP} | Critical pressure drop ratio | 0, 5 (typical) | |
| Y | Expansion factor | $Y = 1 - \frac{{X}_{P}}{3 {F}_{k} {X}_{PT}}$ | |

| Subscript symbol | Denotation |
|---|---|
| I | Upstream (inlet) |
| 2 | Position 2 |
| i | Position i |
| G | Gas |
| L | Liquid |
| Water | Water fluid |

1.-8. (canceled)

9. A device for measuring rates in individual phases of a multiphase flow, such as in flow of hydrocarbon fluid through a pipe line, comprising a venturi having, seen in the flow direction thereof, a first inlet portion with deceasing cross-section, a second intermediate portion with mainly uniform cross-section, and a third outlet portion with increasing cross-section, and being situated within the pipe line, wherein the venturi is provided with a number of sensors, and the sensors are arranged in mutual distance at different cross-section areas along at least the first of the three portion of the venturi as thereby being able to determine a pressure profile along the venturi as a base for estimating rates for actual rates of the flow.

10. The device according to claim 9, wherein the sensors are arranged in mutual distance along all of the three portions of the venturi.

11. The device according to claim 9, wherein at least three sensors at different cross-section area are used to determine the pressure profile.

12. The device according to claim 9, wherein a minimum of four sensors at different cross-section areas in the venturi is used as thereby being able of achieving redundancy when determining the pressure profile.

13. The device according to claim 9, wherein the sensors are microsensors appropriate for measuring pressure, or alternatively differential pressure.

14. The device according to claim 9, wherein the sensors are differential pressure sensors measuring pressure drop along the respective portions in the venturi.

15. The device according to claim 9, wherein for determination of rates for liquid and gas the multiphase flow is determined by means of the equations:
$$\begin{matrix}{w}_{L} = {A}_{L , i} \sqrt{\frac{2 {ρ}_{L , 1}}{1 - {m}_{L , i}^{2}} ( {p}_{1} - {p}_{i} )} , \\ {m}_{L , i} = \frac{{A}_{L , i}}{{A}_{L , 1}} & ( 6 ) \\ {w}_{G} = {{A}_{G , i} ( \frac{{p}_{i}}{{p}_{1}} )}^{\frac{1}{γ}} \sqrt{{ρ}_{G , 1} {p}_{1} \frac{2 γ}{γ - 1} \frac{1 - {( \frac{{p}_{i}}{{p}_{1}} )}^{1 - \frac{1}{γ}}}{1 - {{m}_{G , i}^{2} ( \frac{{p}_{i}}{{p}_{1}} )}^{\frac{2}{γ}}}} , \\ {m}_{G , i} = \frac{{A}_{G , i}}{{A}_{G , 1}} = \frac{{A}_{i} - {A}_{L , i}}{{A}_{1} - {A}_{G , 1}} & ( 7 ) \\ {A}_{L , i} = \frac{{w}_{L}}{\sqrt{2 {ρ}_{L} ( {p}_{1} - {p}_{i} ) + {ρ}_{L}^{2} {u}_{1}^{2}}} & ( 8 )\end{matrix}$$
where:
w_{L} is the mass flow of liquid,
w_{G} is the mass flow of gas,
uₗ the inlet velocity of liquid,
A, area of measured cross-section,
γ, adiabatic exponent,
p, pressure,
ρ, density,
u, fluid velocity, and
w, rate mass flow.

16. The device according to claim 9, wherein a mathematic model denoting the connection between pressure and rates for liquid and/or gas in multiphase flow is used for estimating rates based on pressure measurements.

17. The device according to claim 10, wherein at least three sensors at different cross-section area are used to determine the pressure profile.

18. The device according to claim 10, wherein a minimum of four sensors at different cross-section areas in the venturi is used as thereby being able of achieving redundancy when determining the pressure profile.

19. The device according to claim 11, wherein a minimum of four sensors at different cross-section areas in the venturi is used as thereby being able of achieving redundancy when determining the pressure profile.

20. The device according to claim 10, wherein the sensors are microsensors appropriate for measuring pressure, or alternatively differential pressure.

21. The device according to claim 11, wherein the sensors are microsensors appropriate for measuring pressure, or alternatively differential pressure.

22. The device according to claim 12, wherein the sensors are microsensors appropriate for measuring pressure, or alternatively differential pressure.

23. The device according to claim 10, wherein the sensors are differential pressure sensors measuring pressure drop along the respective portions in the venturi.

24. The device according to claim 11, wherein the sensors are differential pressure sensors measuring pressure drop along the respective portions in the venturi.

25. The device according to claim 12, wherein the sensors are differential pressure sensors measuring pressure drop along the respective portions in the venturi.

26. The device according to claim 13, wherein the sensors are differential pressure sensors measuring pressure drop along the respective portions in the venturi.

27. The device according to claim 10, wherein for determination of rates for liquid and gas the multiphase flow is determined by means of the equations:
$$\begin{matrix}{w}_{L} = {A}_{L , i} \sqrt{\frac{2 {ρ}_{L , 1}}{1 - {m}_{L , i}^{2}} ( {p}_{1} - {p}_{i} )} , \\ {m}_{L , i} = \frac{{A}_{L , i}}{{A}_{L , 1}} & ( 6 ) \\ {w}_{G} = {{A}_{G , i} ( \frac{{p}_{i}}{{p}_{1}} )}^{\frac{1}{γ}} \sqrt{{ρ}_{G , 1} {p}_{1} \frac{2 γ}{γ - 1} \frac{1 - {( \frac{{p}_{i}}{{p}_{1}} )}^{1 - \frac{1}{γ}}}{1 - {{m}_{G , i}^{2} ( \frac{{p}_{i}}{{p}_{1}} )}^{\frac{2}{γ}}}} , \\ {m}_{G , i} = \frac{{A}_{G , i}}{{A}_{G , 1}} = \frac{{A}_{i} - {A}_{L , i}}{{A}_{1} - {A}_{G , 1}} & ( 7 ) \\ {A}_{L , i} = \frac{{w}_{L}}{\sqrt{2 {ρ}_{L} ( {p}_{1} - {p}_{i} ) + {ρ}_{L}^{2} {u}_{1}^{2}}} & ( 8 )\end{matrix}$$
where:
w_{L} is the mass flow of liquid,
w_{G} is the mass flow of gas,
uₗ the inlet velocity of liquid,
A, area of measured cross-section,
γ, adiabatic exponent,
p, pressure,
ρ, density,
u, fluid velocity, and
w, rate mass flow.

28. The device according to claim 11, wherein for determination of rates for liquid and gas the multiphase flow is determined by means of the equations:
$$\begin{matrix}{w}_{L} = {A}_{L , i} \sqrt{\frac{2 {ρ}_{L , 1}}{1 - {m}_{L , i}^{2}} ( {p}_{1} - {p}_{i} )} , \\ {m}_{L , i} = \frac{{A}_{L , i}}{{A}_{L , 1}} & ( 6 ) \\ {w}_{G} = {{A}_{G , i} ( \frac{{p}_{i}}{{p}_{1}} )}^{\frac{1}{γ}} \sqrt{{ρ}_{G , 1} {p}_{1} \frac{2 γ}{γ - 1} \frac{1 - {( \frac{{p}_{i}}{{p}_{1}} )}^{1 - \frac{1}{γ}}}{1 - {{m}_{G , i}^{2} ( \frac{{p}_{i}}{{p}_{1}} )}^{\frac{2}{γ}}}} , \\ {m}_{G , i} = \frac{{A}_{G , i}}{{A}_{G , 1}} = \frac{{A}_{i} - {A}_{L , i}}{{A}_{1} - {A}_{G , 1}} & ( 7 ) \\ {A}_{L , i} = \frac{{w}_{L}}{\sqrt{2 {ρ}_{L} ( {p}_{1} - {p}_{i} ) + {ρ}_{L}^{2} {u}_{1}^{2}}} & ( 8 )\end{matrix}$$
where:
w_{L} is the mass flow of liquid,
w_{G} is the mass flow of gas,
uₗ the inlet velocity of liquid,
A, area of measured cross-section,
γ, adiabatic exponent,
p, pressure,
ρ, density,
u, fluid velocity, and
w, rate mass flow.
